(19) United States
(12) Patent Application Publication
(10) Pub. No.: US 2020/0244211 A1
(43) Pub. Date: Jul. 30, 2020

(54) METHOD AND SYSTEM APPARATUS FOR VERTICAL INSTALLATION OF SOLAR CELL PANEL

(71) Applicants: Michael J. KIM, Reseda, CA (US); Jonghae KIM, Gimpo-si, Gyeonggi-do (KR); Tommy Y KIM, Rancho Palos Verdes, CA (US)

(72) Inventors: Michael J. KIM, Reseda, CA (US); Jonghae KIM, Gimpo-si, Gyeonggi-do (KR); Tommy Y KIM, Rancho Palos Verdes, CA (US)

(21) Appl. No.: 16/642,517

(22) PCT Filed: Jul. 6, 2018
(86) PCT No.: PCT/KR2018/007699

§ 371 Date: Feb. 27, 2020

(30) Foreign Application Priority Data
Aug. 28, 2017 (KR) 10-2018-0031923

(51) Int. Cl. H02S 20/10; H02S 30/10

(52) U.S. Cl. CPC H02S 20/10; H02S 30/10

(57) ABSTRACT

This invention is related to the method and system apparatus for installing large scale solar cell panels on mountain slopes. More specifically, because the existing method of installing solar cell modules above ground requires a broad land area and has the problem of the impossibility of constructing solar photovoltaic power stations that can replace nuclear power plants in a nation with limited land area, this invention is providing the effective method of constructing large scale photovoltaic power generation station and application system apparatus therein that increases the land-use efficiency by providing the system apparatus and method for tiered installation of several solar cell panels in top-to-bottom vertical direction using abandoned mountain slopes. In addition, this invention provides technology that improves the lifespan of photovoltaic power generation system semi-permanently by panel replacement and simple maintenance of panels by hoisting up or down with a motor winch through rails for installation and disassembling of the system thereof. Thus, this invention provides the most economic solution to build a solar power station utilizing mountain slop, safe against strong wind by connecting 4 axes of panels with rails, and that improves the sunlight collection efficiency based on arbitrary variation of reflecting plane of each frame by 360 degrees with a length variable connection tool between each corner of solar cell panel frames and rails.

### FIELD OF THE INVENTION

The present invention is an invention the applicant has issued a circle Application No. 10-2017-0078521 favor continuous improvement used. The existing lateral system to install solar cell panels for solar power generation on earth (Horizontal system) is a problem that spacious land required and you cannot build a solar power plant to replace the nuclear power plant in this narrow country area of land this because the present invention using the abandoned slopes inclining a large-scale solar power plant in abandoned increase the multi-stage installation longitudinally system (vertical system) land-use efficiency by providing an apparatus and method for a plurality of solar cell panels in a vertical longitudinal Mountain It relates to an effective method of construction and its application system unit.

### BACKGROUND OF THE INVENTION

The existing method of installing solar cell modules above ground requires a broad land area because solar cell panels are installed horizontally. Because the average installation area is about 10 m² including the service area, a land area of 14,000,000 m² is required in order to construct photovoltaic system of 140 MW (based on Kori 5 nuclear power plant), which is practically impossible because the area exceeds about 1400 hectare.

When solar cell panels are installed under the existing method on a flatland, solar cell panels are installed by adjusting or remotely controlling the panel frame slope composed of a number of solar cells. The method, however, requires a broad area of land because frames need distance in order to prevent frames shading each other due to the high height of panels.

In addition, the existing flatland installation method cannot be implemented correctly when the installation is made on steep mountain areas, which leads to the difficulty of maintenance and repair, in addition to the need for installing heavy solar cells on a mountain slope, causing solar cell panels to be easily damaged or destroyed due to the strong wind on mountain slopes.

In addition, the existing solar cell panel installation method on mountain slopes has the issue of being able to use only the south side of a mountain. As such, an effective solarcell installation method that utilizes all sides of a mountain from the south side as well as the north, east, and west sides.

The existing solar cell panel installation system is a prefabricated mount that consists of fixed-type whereby the reflection angles of panels are fixed and installed and variable-type of free adjustment of panel slopes among panels.

The apparatus registered under the Korean Patent No. 10-1108713 (Photovoltaic system with ease of gradient adjustment) used hinges to connect a solar cell mount with solar cell panels and changed the gradient of the hinge axis, which, however, had the issue of damaging the panels when strong wind or the weight the solar panel itself caused the panels to fall backward.

Under the Korean Patent No. 10-1670346 (Photovoltaic system for scarfed roof installation), the upper frame that supports solar cell panels and the lower frame that supports the upper frame is composed in the form of assembly and the gradients of the panels are fixed and installed. However, the problem of the impossibility of free adjustment of gradient persists.

Under the Korean Patent No. 10-0887723 (Floating fixation structure for sunlight collection panel), a floating structure for installing sunlight collection panels on the river or lake is patented. However, there is a problem that the power generation cost is twice as high compared with the existing thermal power generation due to the high installation cost.

Under the U.S. Pat. No. 6,060,658 (Pole having solar cells), the specified technology constructs a street map being operated by the power supply from a solar cell module that is installed on the 360 degrees surface of a pole. However, the power generation efficiency is low because no consideration is given to the angle of the slope or direction of the panel that collects sunlight.

Under the U.S. Pat. No. 8,776,454B2 (Solar array support structure mounting rail and method of installation thereof), solar cell panel mounting methods of using rails are specified. However, the method still requires a broad land area because solar cell panels are mounted on rails that are installed horizontally.

In 1954, Bell Labs recorded 4% of efficiency with silicon (Si) solar cells, which has been improved to around 15% as the efficiency of mass-produced cells is achieved by improving the manufacturing process and purity of raw materials. The emergence of the metal oxide perovskite in 2012 increased the mass production efficiency over 22% and reduced the manufacturing cost could be lowered to 1/3 or less of silicon solar cells.

Accordingly, the Grid Parity, which means the cost of photovoltaic power generation required for generating 1 KW of electricity becomes equal to that of fossil fuel-based general power generation, has already been reached. However, the difficulty of securing large areas of land for constructing large scale photovoltaic power stations that can replace fossil fuel-based power generation systems persists.

In countries worldwide, it is recognized that nuclear power generation based on nuclear division is vulnerable to earthquakes, and nuclear power plants may be bombed in wartime, causing damage in the size of an atomic bomb. Accordingly, for example, Israel has never installed nuclear power plants, and the tendency to avoid nuclear power is increasing in countries where there is a danger of war or terrorism.

In addition, power stations using coal-based thermal power generation are being closed down by many countries due to the pollution issue. Thus, a groundbreaking system must be developed to provide industrial photovoltaic power generation technology that replaces thermal or nuclear power generation while reducing the generation cost.

### SUMMARY OF THE INVENTION

### Technical Problems to be Solved

Existing solar cell panels had the problem of increasing generation costs due to land prices. In addition, the resistance against panel reflections created difficulties in constructing photovoltaic power generation systems of large scale in cities.

Due to the aforementioned problems, some countries are experimenting with installing photovoltaic power generation facilities on the floor of salt fields or on roads. As a solution, a method of installing solar cell panels on mountain areas is being suggested. However, because the only south side of mountain areas can be used, a technology that can utilize all sides of inexpensive mountain areas should be developed.

This invention provides effective and economical method and system apparatus of installing large scale solar cell panels for photovoltaic power generation on slopes of all sides (east, west, south, north) of abandoned mountains in order to reduce photovoltaic power generation cost and aims at providing large scale photovoltaic power generation facility establishment technology that replace thermal power generation stations by using mountains.

### Measures for Solving the Problems

In order to achieve the aforementioned purposes, this invention improves the existing solar cell panel installation method in the horizontal direction into the installation in a vertical direction and thereby provides system technology and methods that dramatically reduce the installation area compared to existing methods.

In addition, this invention provides the technology that enables the construction of large scale photovoltaic power generation stations that utilize all sides of slopes of an abandoned mountain by installing solar panels vertically.

The existing invention (Korean patent application No. 10-2017-0078521 submitted by the applicant) that uses mountain slopes only allows installation on the south side of a mountain. However, this invention enables solar panels to be installed on a tower-shaped steel structure and thereby provides useful technology that allows solar panels to be installed without being restricted by the direction of a mountain slope.

Moreover, the existing mountain slope installation method included the difficulty of installing large-sized and heavy solar cell panels on rugged mountain terrain. However, this invention provides effective ways to install or mount by hoisting up and down heavy solar cell panels with an alternating or direct current motor winch on a rail.

### Effect of the Invention

This invention provides an effective and economical solution of installing large amounts of solar cell panels regardless of the direction or gradient of mountain slopes and thereby has the effect of significantly reducing photovoltaic power generation cost because of the land price of the mountain slopes is significantly cheaper than that of flatland or farmland.

This invention is in the structure of fastening the four axes of solar cell panels on a slope. Thus, this invention has the effect of maintaining the optimal power generation efficiency because the method is safer against strong wind compared to the existing rotational

axis-based method for gradient adjustment, enables changes in panel gradients after installation, and allows the slope to change by 360 degrees.

This invention provides a system technology for constructing large scale photovoltaic power generation panels on inexpensive mountain slopes and therefore has the effect of enabling photovoltaic power generation stations by replacing nuclear or thermal power plants and by constructing a large scale photovoltaic power generation panel complex.

This invention has the effect of enabling a large photovoltaic power generation station equal to the size of a thermal or nuclear power plant by significantly reducing power generation cost and of causing no civil complaints by installing the systems of this invention on inexpensive remote mountain areas without the influence of reflection rays or damage to fine city view.

This invention has the effect of reducing power generation costs by increasing land-use efficiency compared to the existing horizontal installation method because this invention installs a number of solar cell panels vertically on a tower-shaped steel structure.

This invention provides effective technology that enables the utilization of all sides of mountain slopes because this invention installs solar cell panels on a tower-shaped steel structure and thereby allows unrestricted adjustment of panel directions for 360 degrees.

This invention has the effect of making the decommissioning cost dramatically and significantly inexpensive compared to nuclear power plants and allows semi-permanent extension of the lifespan of photovoltaic power generation stations based on the ease of after service (A/S) or replacement of solar cell panels with a motor winch that hoists up or down to install or disassemble solar cell panels with chains that connect the upper and lower parts of several solar cell panels between rails.

### BRIEF DESCRIPTION OF THE DRAWINGS

FIG. 1 is the tower-shaped system diagram of this invention.

FIG. 2 is the mountain slope system diagram of this invention.

FIG. 3 is the variable gradient system diagram of this invention.

FIG. 4 is the fixed gradient system diagram of this invention.

FIG. 5 illustrates the system installation of this invention.

### DETAILED DESCRIPTION OF THE INVENTION

In terms of the system apparatus of placing solar cell panels on mountain slopes, in relation to the south side of a mountain slope and in the vertical direction from the upper part and lower part of the mountain, a number of rails are placed and wire rope winding tools between the upper and lower parts in between of the aforementioned rails are constructed. As such, the system apparatus provides solar cell mounting system apparatus with a feature that allows disassembling by hoisting up or down the mounting frame for several solar cell panels, of which the upper and lower parts are connected to be removable, with the aforementioned wire rope winding tool between the above rails.

In the above form, the embodiment is constructed to improve the sunlight collection efficiency per panel by composing it to be variable by 360 degrees of the gradient of each frame with the variability of length of each connection tool based on the addition of a connection tool or by connecting with nuts and bolts between rails and solar cell panel mounting frame.

When the above form is constructed on a tower-shaped steel structure instead of mountain slopes, the direction of the steel structure can be freely changed, providing the optimal form for mounting a number of solar cell panels regardless of the direction of a mountain slope.

The details explanation of the attached Figures of this invention is provided as follows.

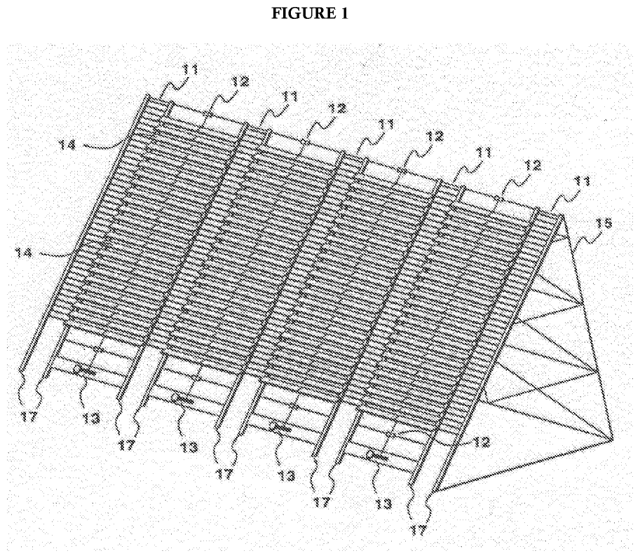

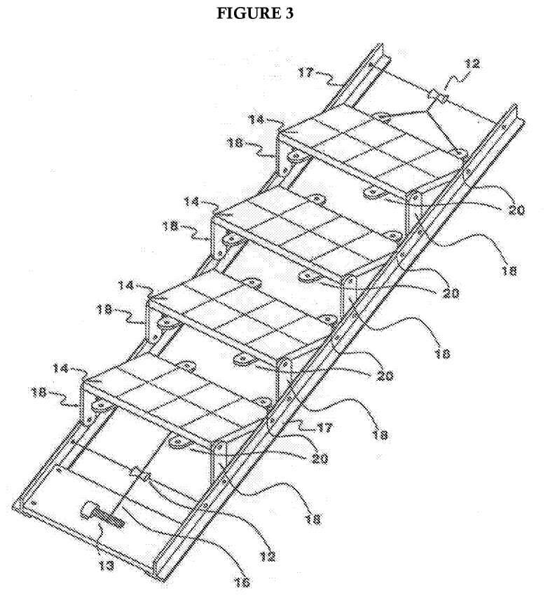

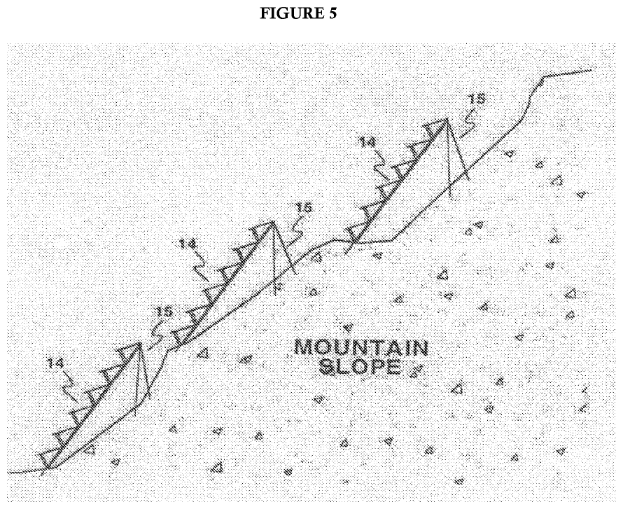

FIG. 1 is the tower-shaped system diagram of this invention, FIG. 3 and FIG4 are the solar cell panel chain diagram of this invention, and FIG. 5 is an illustration of the system installation.

As shown in FIG. 1, the system of this invention is composed of the installation of a number of rails (17) on the south side of the tower-shaped steel structure (15), the construction of chains (FIG. 3/FIG4) of frames that connect the upper and lower parts of the frame for mounting (14) of several solar cell panels between rails, and the system of mounting by hoisting up or disassembling by hoisting down several solar cell panels by winding the wire rope with the wire rope winding tool (13) consists of a motor winch and other items via the wire rope rotation axis (12) installed on the upper and lower parts of the rail by connecting the wire rope (16) on the most upper side of the above frame chain.

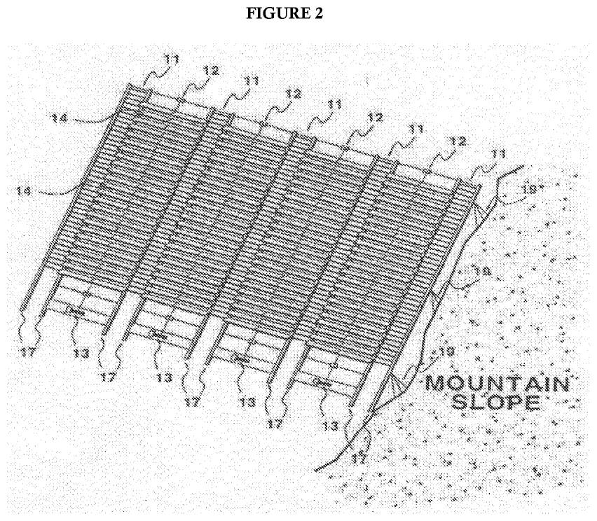

In the above system, a ladder (11) that is connected to each rail between the two rails (17) mounted with the chain (FIG. 2/FIG 3) of the frame of the solar cell panel frames can be constructed, based on which provides a solar cell panel mounting system that is safe against strong wind by letting the wind pass through as well as easy accessibility to each solar cell panel.

In the above system, the wire rope winding tool (13) may be replaced with a steel chain or rope connected with a steel loop and may be used with a winding device utilizing a complex pulley or be composed of a motor winch device.

In addition, the sunlight collection efficiency can be adjusted to be the highest by changing and fixing the gradient of the reflecting plane of solar cell panels to 360 degrees with the variable connection tool (18) or by fixing between the frame (14) that is mounted with each solar cell panel and the rails (17) left and right sides of the frame with bolts and nuts as shown in FIG. 3 after hoisting up several solar cell panels.

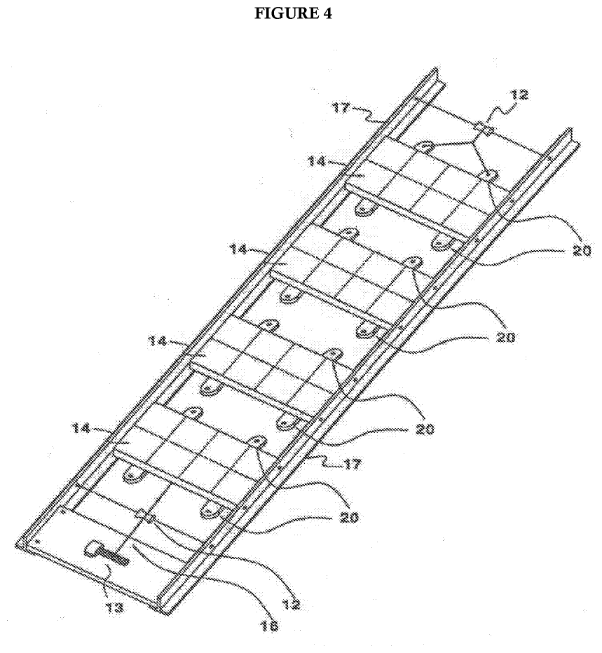

As shown in FIG. 4, by connecting the frames of several solar cell panels and rails with bolts and nuts, the angle or direction of the rail itself can be varied. Accordingly, the system can be composed to increase the sunlight collection efficiency of solar cell panels.

This invention divides and mounts several panels on rails, allowing ventilation via ladders on the left and right side of the panel and through the upper and lower gaps between panels. Thus, this invention provides an installation method that is useful against and can withstand strong wind.

This invention has the effect of making the decommissioning cost significantly inexpensive compared to nuclear power plants and allows semi-permanent extension of the lifespan of photovoltaic power generation stations based on the ease of after service (A/S) or replacement of solar cell panels with a wire rope winding tool (13) including a motor winch or a winder that hoists up or down to install or disassemble solar cell panels with chains that connect the upper and lower parts of several solar cell panels between rails.

Because this invention installs rails (17) on a tower-shaped steel structure, this invention allows the use of all sides of mountains (east, west, south, north) by allowing the rails to be always installed toward the south by installing the rails on the south side of the steel frame.

In this invention, a tower-shaped refers to steel frame structures of an A-shaped tower such as a power transmission tower constructed on a mountain, Eiffel tower type in Paris, France, or a □ shaped steel tower. By reinforcing the south side of the tower, several rails (17) are installed, which are constructed as L-shaped, ™ shaped, or U shaped section steel. In addition, connection holes are perforated on the side of the rails for bolts and nuts connection, allowing attachment or disassembly of connection tools or connecting between solar cell panels and rails with bolts or nuts. This invention does not restrict or limit the shape or composition of the rails or the steel tower.

FIG. 2 is a diagram of installing solar cell panels of this invention by directly constructing rails on the south side of a mountain slope without constructing a tower-shaped steel structure in the system of this invention.

As shown in the figure, this invention is composed of several rails (17) that connect the steel structure for mounting rails on mountain slope or make the connection with anchor bolts, rock bolts, or soil nailing on bedrock on mountain slope, the construction of chains (FIG. 3/FIG4) of frames that connect the upper and lower parts of the frame for mounting (14) of several solar cell panels between rails, and the system of mounting by hoisting up or disassembling by hoisting down several solar cell panels by winding the wire rope with the wire rope winding tool (13) consists of a motor winch and other items via the wire rope rotation axis (12) installed on the upper and lower parts of the rail by connecting the wire rope (16) on the most upper side of the above frame chain.

In the above system, a ladder (11) that is connected to each rail between the two rails (17) mounted with the chain (FIG. 2/FIG 3) of the frame of the solar cell panel frames can be constructed, based on which provides a solar cell panel mounting system that is safe against strong wind by letting the wind pass through as well as easy accessibility to each solar cell panel.

In the above system, the wire rope winding tool (13) may be composed of a steel chain or rope and may use a winding device utilizing a complex pulley or be composed of a motor winch device.

As aforementioned, the sunlight collection efficiency can be adjusted to be the highest by changing and fixing the gradient of the reflecting plane of solar cell panels to 360 degrees with a variable connection tool (18) or by fixing between the frame (14) that is mounted with each solar cell panel and the rails (17) left and right sides of the frame with bolts and nuts after hoisting up several solar cell panels.

This invention divides and mounts several panels on rails, allowing ventilation via ladders on the left and right side of the panel and through the upper and lower gaps between panels. Thus, this invention provides a useful installation method that is useful against a strong wind.

This invention has the effect of making the decommissioning cost significantly inexpensive compared to nuclear power plants and allows semi-permanent extension of the lifespan of photovoltaic power generation stations based on the ease of after service (A/S) or replacement of solar cell panels with a wire rope winding tool (13) such as a motor winch that hoists up or down to install or disassemble solar cell panels with chains that connect the upper and lower parts of several solar cell panels between rails.

When a connection tool is constructed that can adjust the length between rails from selective 2 sides from 4 sides (up, down, left, right) of the solar cell panel frame, the gradient of each frame can be adjusted up and down or left and right directions.

In addition, when a motorized or hydrodynamic connection tool is constructed that adjusts the length between rails on the left and right sides of the upper side as well as lower side of the frame, it can be constructed to allow varying angle and slope of the frame by 360 degrees by adjusting the length of each connection tool based on remote control.

In the aforementioned composition, when the frame of a solar cell panel is large, extra reinforcement or support can be constructed between each connection part on the lower part of the frame in order to withstand the weight of solar cell panels. In addition, by additionally constructing extra connection parts as an option between rectangular connection parts, a frame can be made as a prefabricated structure that can be assembled and that is mounted with a solar cell panel according to the size or weight of a solar cell panel.

When the system of this invention is constructed on mountain slope, a safer panel mounting system is provided by dispersing the weight based on the lattice structure of several horizontal and vertical rails that is created by connecting vertical rails for several solar cell panel mounting on the installation of horizontal rails after constructing a separate structure in regions without bedrocks, by connecting several horizontal rails on slope bedrock with anchor bolts, rock bolts, or soil nailing, or by fixing and installing by suspending a steel structure on the top of the mountain slope after bending it or attaching it on the rail on the top of the mountain slope in order to support the weight of the rails attached with solar cell panels. In addition, according to the topography of a mountain slope, vertical rails can be constructed in the form of a straight line, curved line, or tiered type.

This invention has the feature of ease of installation and disassembly because the method of installing solar cell panels on a steel structure or mountain slope is composed of the stage of mounting several rails vertically on the south side of a steel structure or on mountain slope, the stage of constructing a winding tool between the upper and lower parts between the rails, the stage of constructing chains of the solar cell panel mounting frame that connects the upper and lower parts of several solar cell panel frames, and the stage of allowing the installation by varying toward a selected direction of 360 degrees, changing the gradient of a panel with a connection tool or bolts and nuts between rails and solar cell panel mounting frame by hoisting up the chain of the aforementioned solar cell panel mounting frame with a wire rope winding tool in connection with the rail between the above rails, or disassembling by hoisting down.

In the aforementioned method, the steel structure can be additionally installed on a rooftop, roof, or outer wall of a building instead of a steel tower-shaped steel structure. In addition, the system of this invention can be constructed by mounting solar cell panels on a steel structure laid down on the ground then raising the steel structure with a crane. Also, under this invention, solar cell panels can be directly installed without a frame orby directly mounting solar cell panel frames on the steel structure without including a rail or a winding tool.

As such, this invention provides an effective way of establishing large scale solar cell panel complex on an abandoned mountain slope, provides the system of the varying direction of 360 degrees of the gradient in addition to varying gradient of panels while being safe against the strong wind by connecting solar cell panels from 4 axes. In addition, this invention provides system technologies that allow the establishment of large scale photovoltaic power generation systems that can replace nuclear and thermal powerplants in the future by semi-permanently improving the life span of photovoltaic power generation system in addition to the ease of installation and disassembly of solar cell panels.

Accordingly, because this invention can be utilized and used in a variety of formats and ways within the scope that does not depart from the technological ideas or main characteristics of this invention, any and all modifications and changes that fall within the equivalent scope of the Patent Claim Scope of this invention shall fall within the scope of this invention.

### INDUSTRIAL APPLICABILITY

This invention can be applied to a photovoltaic power generation station construction business that can replace nuclear or thermal power generation in the future because this invention allows the economic construction of a photovoltaic power generation facility on a mountain slope in remote areas where land value is inexpensive. In addition, this invention can activate small scale power generation businesses because an owner who owns a mountain can construct photovoltaic power generation towers of this invention as if planting trees on his or her mountain.

### SEQUENCING LISTING OF THE DRAWING

1, 11; Ladder
2, 12; Rotation axis
3, 13; Wire rope winding tool
4, 14; Solar cell panel
5, 15; Tower-shaped steel structure
6, 16; Wire rope
7, 17; Rail
8, 18; Connection tool with the rail
9, 19; Auxiliary device for rail attachment
10, 20; Connection part between panels

1-14. (canceled)

15. A system apparatus for installing solar cell panels in top-to-bottom vertical direction, comprising;
(1) a plurality of rails being vertically installed on the south side of a tower-shaped steel structure,
(2) a wire rope winding means that is constructed between the upper part and lower part between the said rails,
(3) a chain of solar cell panel mounting frames connecting the upper part and lower parts of a plurality of the solar cell panel mounting frames in a vertical direction,
(4) a system apparatus for mounting the chain of solar cell panel mounting frames with a composition of varying gradient and slope of each frame toward a selected direction around 360 degrees with a connection tool to connect the solar cell panel mounting frames and the rails with bolts and nuts after hoisting up the chain of solar cell panel mounting frames with the wire rope winding means in connection with rails between the said rails.

16. The system apparatus of claim 15, wherein the connection tool is constructed to adjust the length between the rails and each solar cell panel mounting frame from selective side from 4 sides (up, down, left, right) of the solar cell panel mounting frame and whereby the gradient and slope of each frame can be adjusted by the length of the connection tools of each side selectively.

17. The system apparatus of claim 15, further comprising a ladder between the rails that mounted with the chain of solar cell panel mounting frames to enable easy access for maintenance and installation of the system thereof.

18. The system apparatus of claim 15, wherein the wire rope winding means comprising a wire rope with steel chain connecting steel loops in order or a rope.

19. A system apparatus for mounting of solar cell panels on mountain slopes, comprising;
(1) a plurality of rails installed vertically between the top and lower parts of a mountain slope in relation to the south side of a mountain slope,
(2) a wire rope winding means constructed between the upper and lower parts between the said rails,
(3) a chain of solar cell panel mounting frames that connects the upper and lower parts of a plurality of solar cell panel mounting frames as a detachable type in a vertical direction,
(4) a system apparatus for mounting the chain of solar cell panel mounting frames with a composition of varying gradient and slope of each frame toward a selected direction with a connection tool to connect the solar cell panel mounting frames and the rails with bolts and nuts after hoisting up the chain of solar cell panel mounting frames with the wire rope winding means in connection with rails between the said rails.

20. The system apparatus of claim 19, wherein the connection tool is comprising selectively from motorized and hydrodynamic type to vary the slope and gradient of a solar cell panel toward a selected direction of 360 degrees by remote control.

21. The system apparatus of claim 19, further comprising a ladder between the rails that mounting the chain of solar cell panel mounting frames to enable easy access for maintenance and the rails to be selectively connected in the form of a straight line, curved line, or tiered type according to the topography of the mountain slope.

22. The system apparatus of claim 19, further installing the rails in vertical direction after installing a plurality of horizontal rails on bedrock or a separate structure according to the mountain slope topography.

23. A method for installing solar cell panels, comprising the steps of;
(1) constructing a plurality of rails vertically on the south side of a structure for mounting a plurality of solar cell panel mounting frames,
(2) constructing a wire rope winding means between the upper and lower parts between the rails for installing a plurality of solar cell panel mounting frames,
(3) constructing a chain of a plurality of solar cell panel mounting frame that connects the upper and lower parts of each solar cell panel mounting frame together, and
(4) connecting the solar cell panel mounting frames and rails with bolts and nuts after hoisting up the chain of the said solar cell panel mounting frames with the wire rope winding means in connection with rails between the said rails, changing the gradient and slope of each panel with a connection tool and variably install in a selected direction, and disassembling by hoisting down the chain of a plurality of solar cell panel mounting frames for maintenance if needed.

24. The method of claim 23, wherein the rails comprising selectively L-shaped, ⊥ shaped, and U shaped section steel, perforating connection holes on the side of the rails for bolts and nuts connection, and adjusting a gradient and slope of solar cell panel in a selected direction by adjusting the length variation of each connection tool.

25. The method of claim 23, wherein the wire rope winding means and the chain of solar cell panel mounting frames to be installed selectively according to the structure for mounting solar cell panel frames.

26. The method of claim 23, wherein the rails to be constructed by selectively connecting rails among the form of a straight line, curved line, and tiered type according to the structure and direction of the said solar cell panel.

27. The method of claim 23, further comprising a separate steel structure on the top of the rails for attaching on the top of the mountain slope in order to support the weight of the rails attached with solar cell panels.

28. The method of claim 23, wherein the variation of gradient and slope of a solar cell panel to be adjusted to selected direction with the connection tool by using bolts and nuts to connect between solar cell panels and rails without separately constructing a frame for each solar cell panel.
